(19) United States
(12) Patent Application Publication
(10) Pub. No.: US 2025/0135818 A1
(43) Pub. Date: May 1, 2025

(54) A-Arms For A Vehicle

(71) Applicant: Stephen Kariniemi, Phoenix, AZ (US)

(72) Inventor: Stephen Kariniemi, Phoenix, AZ (US)

(21) Appl. No.: 18/914,166

(22) Filed: Oct. 12, 2024

Related U.S. Application Data
(60) Provisional application No. 63/593,963, filed on Oct. 28, 2023.

(51) Int. Cl. B60G 7/00

(52) U.S. Cl. CPC B60G 7/001; B60G 2200/14; B60G 2206/124; B60G 2300/07

(57) ABSTRACT

An A-Arm assembly for All-Terrain Vehicles. The A-arm assembly comprises an A-Arm with a slug. The slug can enhance assembly of an A-Arm and reduce manufacturing costs. An A-Arm slug can enable efficient assembly of A-Arms to an ATV. The slug can accommodate different style A-Arms, for example, the slug can have a beveled or angled face to match a square end of an A-Arm. Alternatively, the slug can have an angled spindle connecting portion and square faces that match an A-Arm.

### FIELD OF THE INVENTION

The present invention generally relates to 4 wheeled vehicles, and more specifically to all-terrain vehicles

The present application incorporates entire contents by reference, U.S. Pat. No. 9,493,191 to Kariniemi filed Apr. 10, 2014, entitled “Arcuate Frame For A Vehicle” and U.S. application Ser. No. 15/385,837, filed Dec. 20, 2016, entitled “An Arcuate Frame For A Vehicle”, and U.S. Pat. No. 10,766,534 to Kariniemi filed Jul. 3, 2018, entitled “Front A-Arms for a Vehicle. The present application also incorporates and claims priority to U.S. provisional application No. 63/593,963 to Kariniemi filed Oct. 28, 2023.

### BACKGROUND OF THE INVENTION

All-terrain vehicles (hereinafter “ATV”) typically have a shorter wheelbase which gives the ATV increased maneuverability over longer wheelbased ATVs such as sandrails, desert trucks, and dune buggies. The shorter wheelbase however can have shortcomings compared to a longer wheelbase, for example, a shorter wheel base can have a rougher ride due in at least part to having shocks with less travel. It remains desirable to have an ATV with increased maneuverability along with more travel.

### SUMMARY OF THE INVENTION

It has been recognized that it would be advantageous to develop an ATV with increased maneuverability and increased travel. In one embodiment, an ATV has a frame (e.g., an arcuate frame assembly according to U.S. Pat. No. 9,493,191 to Kariniemi), and shocks attached to the frame assembly. The shocks attach to the frame assembly and to a spindle assembly, or tower, such that the shocks can attach to the spindle below an axis line through a center of a front wheel, if desired. The front top A-Arms can be arched to provide clearance around the shock, if needed, else straight A-Arms can be utilized. The front bottom A-Arms may be straight or arched to provide additional ground clearance. In one embodiment the A arms attach to a slug. The slug may have two beveled faces, and a hole that is straight. The beveled faces may be set at an idealized angle to maximize travel. In one embodiment, center of travel is located, for example total travel may be 24″. In one embodiment an 8″ spindle may be used. On each end of the spindle may be a ball (e.g., a uniball spherical bearing). In one embodiment a bolt may pass into the uniball and the bolt may thread into the spindle. The uniball may be surrounded by a bearing. The bearing may be surrounded by a race. The race can be welded to the A-arm(s) at the desired angle to maximize the travel. So the end of the a arm may be angle cut and may also be round cut to fit or be attached to the race. With the slug, the angles can be accurately determined, e.g. a computer software such as solid works. In other embodiments the slug may have a hole at an angle and the faces on the slug may be beveled less or have no bevel, i.e, flat. During a-arm assembly the a-arms are butted to the slug faces, that may be beveled. The slug can completely surround the race or only partially surround the race. A solid connection and strength may be desired and determine how much the slug surrounds the race. The slug can be wider or narrower to help clear the shock coils that fit between the two upper A-arms. The slug can also be higher or lower to firmly attach to the slug. Different configurations of the A-arm(s) and slug can be used to accommodate desired uses, e.g., travel. An All-Terrain Vehicle (ATV) comprising; a frame assembly; a spindle assembly; a first A-Arm attached to the frame assembly; and wherein the first A-Arm is attached to the spindle assembly via a slug. The ATV wherein the slug has a face that is beveled. The ATV wherein the first A-Arm has an end that is beveled to match the slug face. The ATV wherein the first A-Arm has an end that is square to match the slug face. The ATV wherein the slug has a spindle connection portion that is angled. An A-Arm assembly for a Vehicle comprising; a first A-Arm having a first A-Arm first end and a first A-Arm second end; and wherein the first A-Arm second end comprises a slug. The A-Arm assembly wherein the slug face is beveled. The A-Arm assembly of claim 6 wherein a spindle connecting portion of the slug is at an angle.

Additional features and advantages of the invention will be apparent from the description which follows, taken in conjunction with accompanying drawings, which together illustrate, by way of example, features of the invention.

### BRIEF DESCRIPTION OF THE DRAWINGS

FIG. 1 shows an ATV in accordance with an embodiment.

FIG. 2 shows a side view of an A-arm attached to a slug and an ATV in accordance with an embodiment.

FIG. 3 shows an A-Arm attached to a slug in accordance with an embodiment.

FIG. 4 shows a slug with angled faces, according to one embodiment.

FIG. 5A and FIG. 5B show a slug with an angled hole, according to one embodiment.

FIG. 6A and FIG. 6B show a slug in accordance with an embodiment.

### DETAILED DESCRIPTION

Reference will now be made to some embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

An ATV with A-Arms in accordance with various embodiments are disclosed herein and examples are illustrated in the Figures. The A-Arms may be attached to an ATV frame assembly. For example, the A-Arms may be constructed from a structural component or member, e.g., a truss or joist made out of a tubular-shaped steel alloy, or a steel or aluminum plate, or any rigid or semi-rigid material or cross sectional shape. For example, the top A-Arms may be made out of a plate, one for a passenger side and one for a drivers side. The plates may have a hollowed out middle section to provide clearance for a shock for example. In an alternative embodiment, the top A-Arms may be made out of individual beams or bars, for example a passenger side may have a top fore A-Arm bar and a top aft A-Arm bar and the drivers side may have a top fore A-Arm bar and a top aft A-Arm bar. The structural component (e.g., A-Arm) may have a tubular construction typically ranging from approximately 0.5 inches to 3 inches in diameter or whatever diameter is required for adequate strength. The A-Arms can be shaped to accommodate longer shocks that are attached to a point below an axle line through a center of a front wheel. Attaching the shock to a spindle at a location below an axis line can create a need to have the A-Arms be arched to provide clearance around the shock. The A-arms can be attached to a slug. The slug can be shaped to ease manufacturing of the A-arms.

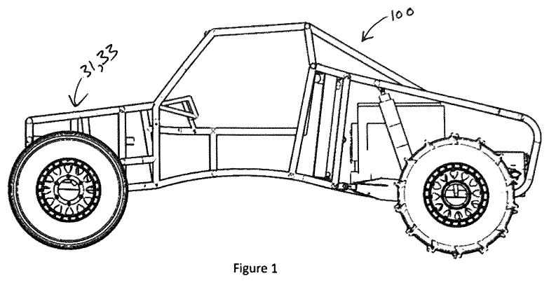

FIG. 1 shows an ATV in accordance with an embodiment. An ATV can utilize a slug for an A-arm in accordance with this description. In one embodiment, the ATV may have an arcuate shape as shown in FIG. 1. The A-arm can be connected to frame 31,33.

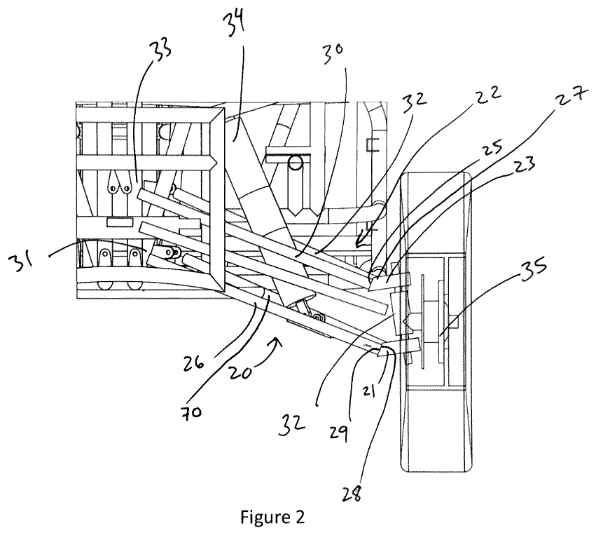

In one embodiment, as shown in FIG. 2, bottom A-Arm 20 may be attached to a bottom slug 21. As shown in FIG. 2, the slugs 21,23 may have beveled faces 25,27,28,29. The bottom slug 21 may have a bottom slug first face 28 (e.g., front first face) and a bottom slug second face 29 (e.g., a rear second face). The bottom A-Arm 20 may have a bottom front facing portion 26 and a bottom rear facing portion 70. The bottom front facing portion 26 of the bottom A-Arm 20 may be attached to the bottom slug front face 28 and the bottom rear facing portion 70 of the bottom A-Arm 20 may be attached to the bottom slug rear face 29. The A-Arms (20,22) have a distal end and a proximal end and the A-Arms (20,22) can attach to the slug (21,23) at the A-Arms distal end and attach to the frame assembly at A-Arms proximal end or alternatively near the respective ends. The bottom A-Arm 20 may be attached to an ATV frame assembly 31. The top slug 23 may have a top slug first face 25 (e.g., front first face) and a top slug second face 27 (e.g., a rear second face). The top A-Arm 22 may have a top front facing portion 30 and a top rear facing portion 32. The top front facing portion 30 of the top A-Arm 22 may be attached to the top slug front face 25 and the top rear facing portion 32 of the top A-Arm 22 may be attached to the top slug rear face 27. The top A-Arm 22 may be attached to an ATV frame assembly portion 33. The slugs (21, 23) may be attached to a spindle directly or indirectly. For example, the slugs 21,23 may be attached to a spindle assembly 32. The spindle assembly 32 may have a race and a uniball bearing assembly. The spindle assembly 32 can be attached to the wheel, for example via a wheel assembly or brake assembly 35. In some embodiments the front bottom A-Arm 20 may be arcuate or arched to provide ground clearance. In other embodiments, as shown in FIG. 2, the front bottom A-Arm 20 may be straight. In some embodiments the front top A-Arm 22 may be arcuate or arched to provide clearance around a shock 34. In other embodiments, as shown in FIG. 2, the front top A-Arm 22 may be straight.

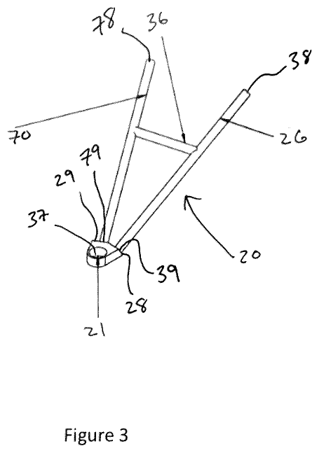

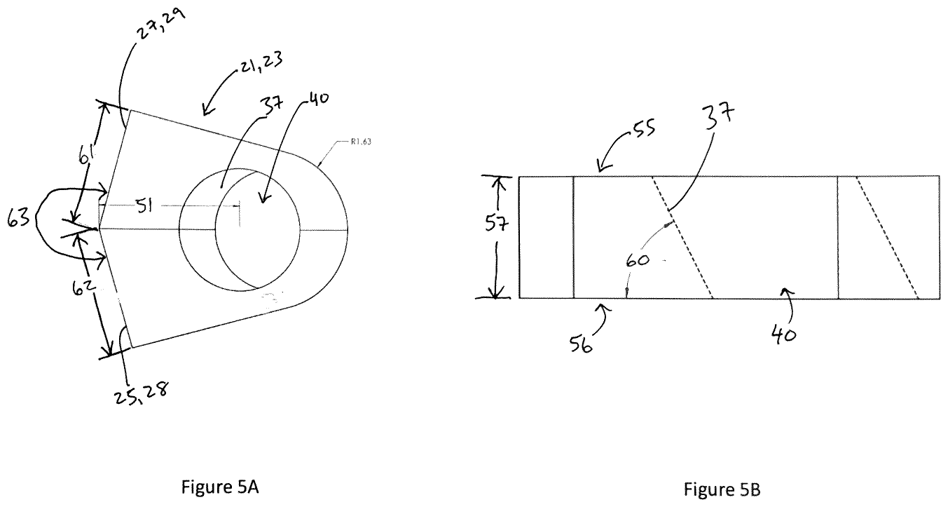

FIG. 3 shows an A-arm assembly 20 shown as an example. The A-Arm assembly 20 has a front facing A-Arm portion 26 and a rear facing A-Arm 70 and an A-Arm connecting portion 36. The A-Arm assembly 20 is connected to a slug, for example slug 21. The slug 21 may have a hole or partial hole and a slug connecting portion 37. The slug hole 37 is a connecting portion to connect to the spindle assembly 32 (shown in FIG. 2). The a-arm can have a first end (e.g. proximal end) 38 and a second end (e.g. distal end) 39. The a-arm second end 39,79 can have a squared off end that is substantially perpendicular to the a-arm length. The a-arm second end 39,79 can mate to face of slug 28,29. The a-arm second end 39,79 in some embodiments, as shown in FIG. 3 may have an angle to match slug face 28,29. In some embodiments of a slug, for example, a slug shown in FIG. 5, slug face (e.g., 28,29, 25,27) can be square and spindle mounting portion 37 can define a hole 40 that is at an angle and an a-arm second end 39,79 would be square to match square slug face. The a-arm second end 39,79 and slug face (28,29,25,27) can have various combinations, example, various angles or non angles of a-arm second end 39,79 to match various angles or non angles of slug face (28,29,25,27).

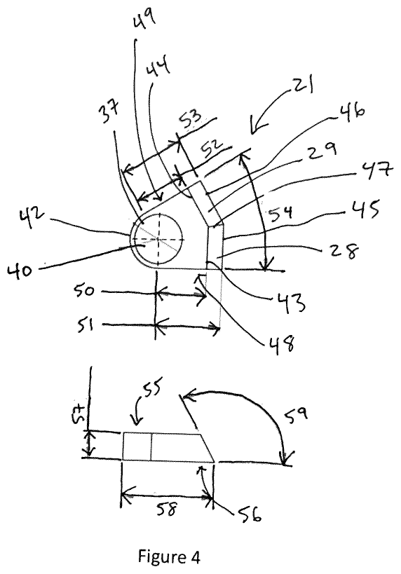

FIG. 4 shows a slug in accordance with an embodiment. Using slug 21 (as shown in FIGS. 2 and 3), the slug can have a first front facing face 28 and a slug rear facing face 29. The slug connecting portion 37 may define a slug hole 40 with a radius of approximately 1.31 inches. The slug connection portion 37 may have a distal section 42 with a thickness of approximately 0.5 inches. The slug front face 28 may have a slug distal edge 43 and a slug proximal edge 45. The slug rear face 29 may have a slug distal edge 44 and a slug proximal edge 46. The slug faces (28,29) may meet at an edge or meeting portion 47. The slug 21 may have a slug front facing side face 48 and a slug rear facing side face 49. The slug front facing side face 48 may have a length dimension 50 of approximately 2.72 inches extending from slug front distal edge 43 in a distal direction to center of hole 40. The slug front facing side face 48 may have a length dimension 51 of approximately 3.56 inches extending from slug front proximal edge 45 in a distal direction to center of hole 40. The slug 21 may have a slug rear facing side face 49 and may have a length dimension 52 of approximately 2.69 inches extending from slug rear distal edge 44 in a distal direction to center of hole 40. The slug rear facing side face 49 may have a length dimension 53 of approximately 3.49 inches extending from slug rear proximal edge 46 in a distal direction to center of hole 40. Slug rear facing side face 49 and slug front facing side face 48 may have an slug side face angle 54 between them of approximately 31 degrees. The slug 21 may have a slug top face 55 and a slug bottom face 56 and the slug may have a slug thickness 57 of 1.5 inches extending between the slug top face 55 and the slug bottom face 56. The slug 21 may have a slug bottom face 56 with a dimension 58 of 5.13 inches extending from slug front proximal edge 45 to distal portion of slug distal section 42. The slug front facing face 28 and a slug rear facing face 29 may have an angle 59 of approximately 119 degrees as shown in FIG. 4. Dimension 63 may be approximately 211 degrees. Hole 40 may have a radius of 1.25 inches. Dimensions described herein are an example of a what a slug may have, and will vary depending on specific desired design attributes.

FIG. 5A and FIG. 5B show an embodiment of a slug 21 in accordance with this disclosure. The slug 21 has a slug connection portion 37 defined by a hole or partial hole 40 or aperture in the slug 21. The slug connecting portion 37 defined by hole 40 is at a non perpendicular angle to slug top face 55 and slug bottom face 56. For example, the hole may be at an angle 60 with a dimension of 63 degrees. Other angle 60 dimensions may be used, depending on particular need. Dimension 51 may be 2.88 inches or other suitable distances. The slug, 21,23 may have slug faces 25,27, 28, 29 respectively. Slug faces 25,27, 28, 29 may be perpendicular to slug top face 55 and slug bottom face 56, for example. FIGS. 5A and 5B show a slug with a tapered or angled hole or substantially angled, and perpendicular faces or substantially perpendicular faces whereas FIG. 4 shows substantially tapered or angled faces 28,29 and a substantially perpendicular hole 40. As shown in FIG. 5A and FIG. 5B, slug faces 25,27 for example, can have dimensional length 61,62 of approximately 2.5 inches. Slug faces 25,27, 28, 29 may be at an angle 63 of dimension 211 degrees. Other dimensions are within scope and dependent on specific application.

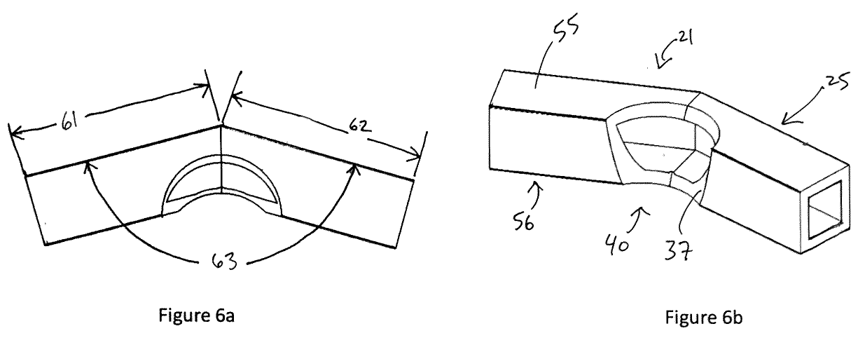

FIG. 6A and FIG. 6B show an embodiment of a slug 21, for example. Slug 21 may have a partial hole 40 or cutout or spindle assembly mating portion 37. Spindle assembly mating portion 37 may be at an angle and slug faces 25,27 may be perpendicular to slug top face 55 and slug bottom face 56. Alternatively spindle mating portion 37 may be perpendicular to slug top face 55 and slug bottom face 56 and slug faces 25, 27 for example may be angled. Other combinations of slug faces 25, 27 and spindle assembly mating portion 37 are contemplated and within scope of this disclosure. It is also contemplated that slug faces 25,27 can be on same side of spindle assembly mating portion, versus on opposite side as shown in FIG. 6A and FIG. 6B. Slug face angle 63 may have a dimension of 149 degrees. Slug faces 25,27, 28, 29 may have a dimension 61,62 length of approximately 4.21 inches. Spindle mating portion 37 may have a radius of approximately 1.25 inches. Slug 21 may be made of a tubular construction, for example a 1.5 inch by 1.5 inch square tubular construction with a wall thickness of 0.25 inches. Slug 21, as shown in FIG. 6A and FIG. 6B may be made of 2 separate portions that are mirror images of each other. This can help reduce manufacturing costs.

The frame can be constructed in various ways, for example, U.S. Pat. Nos. 9,493,191 and 10,766,534 and are incorporated by reference, and describe how an ATV can be made and useful with A-Arm(s) described herein.

It is to be understood that the above reference arrangement are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be practical, it will be apparent to those of ordinary skill in the art that numerous modifications can be made without departing from the principles and concepts of the invention as set forth herein.

What is claimed is:

1. An All-Terrain Vehicle (ATV) comprising;
a frame assembly;
a spindle assembly;
a first A-Arm attached to the frame assembly; and
wherein the first A-Arm is attached to the spindle assembly via a slug.

2. The ATV of claim 1 wherein the slug has a face that is beveled.

3. The ATV of claim 2 wherein the first A-Arm has an end that is beveled to match the slug face.

4. The ATV of claim 2 wherein the first A-Arm has an end that is square to match the slug face.

5. The ATV of claim 1 wherein the slug has a spindle connection portion that is angled.

6. An A-Arm assembly for a Vehicle comprising;
a first A-Arm having a first A-Arm first end and a first A-Arm second end; and
wherein the first A-Arm second end comprises a slug.

7. The A-Arm assembly of claim 6 wherein the slug face attached to the first A-arm second end is square.

8. The A-Arm assembly of claim 7 wherein a spindle connecting portion of the slug is at an angle.
